(19) United States
(12) Patent Application Publication
(10) Pub. No.: US 2003/0162001 A1
(43) Pub. Date: Aug. 28, 2003

(54) Multilayered composite body consisting of leather and thermoplastic elastomers

(76) Inventors: Joachim Rösch, (US); Stephan Hüffer, Ludwigshafen (DE); Georg Igl, Weissach (DE); J?uuml;rgen Bartl, Ludwigshafen (DE); Tilman L?uuml;decke Taeger, Seeheim-Jugenheim (DE); Rainer Klenz, Hassloch (DE); Christophe Ginss, Wolxheim (DE); Erhard Guenther, Hassloch (DE); Michaela Liese, Ludwigshafen (DE)

Correspondence Address: KEIL & WEINKAUF, 1350 CONNECTICUT AVENUE, N.W., WASHINGTON, DC, 20036, US

(21) Appl. No.: 10/257,623

(22) PCT Filed: Apr. 17, 2001
(86) PCT No.: PCT/EP01/04309

(51) Int. Cl. B29C 47/00; B32B 23/02

(52) U.S. Cl. 428/192; 156/245

(57) ABSTRACT

The invention relates to a process for the production of a multilayered composite element which comprises a layer of leather, a layer of a hard component formed from a polymer, which is bonded to the leather layer in certain areas, and a layer of a soft component, which is arranged between the leather component and the hard component, which comprises laying the leather against one mold surface of a mold, positioning the soft component on the leather, and molding the polymer acting as hard component onto the leather layer and the soft component layer at a pressure of at least 50 bar, preferably greater than 100 bar, in particular greater than 180 bar, and at a temperature of greater than 100° C., preferably from 180 to 280° C., in particular from 200 to 250° C., by bonding the leather and the hard component to one another in certain areas at least, with temperature of the mold surface of the mold being controlled, at least during the bonding.

The invention furthermore relates to a composite element obtainable by the process. The composite element is extremely robust, has a soft touch surface and is inexpensive to produce.

The invention relates to a process for the production of a multilayered composite element which comprises a layer of leather, a layer of a hard component formed from a polymer, which is bonded to the leather layer in certain areas at least, and a layer of a soft component, which is arranged between the leather and the hard component.

The invention furthermore relates to a multilayered composite element obtainable by the process according to the invention.

In vehicles in the upper price category, it is usual, in order to create an exclusive impression, to line the interior of the vehicle with leather. To this end, preshaped moldings, such as door panels, dashboards, central consoles, sun visors or handles, are bonded to leather structures which have been cut to appropriate size and optionally preshaped. In particular in the case of non-planar surfaces, the leather must, in a separate working step, either be sewn in shape or thermoformed separately. This type of lamination of moldings can only be automated with difficulty and is very expensive owing to the high proportion of manual work. The covering methods customary hitherto also give only unsatisfactory results. Thus, emissions of solvents and residual monomers from the adhesive systems are unavoidable. In particular in automobiles, the coverings are subjected to very extreme temperature or humidity variations, and consequently shrinkage phenomena can cause the leather covering to be discarded. Furthermore, only selected nap leather of top quality has hitherto been suitable for conventional covering methods.

Other areas in which lamination of moldings is used are, for example, suitcases and furniture. Thus, for example, hard plastic armrests, backrests and seats of chairs are laminated with leather.

Besides the visual impression of the leather-laminated moldings, the impression formed on touching is usually also important. The surface should have a pleasant feel, i.e. a soft touch. In particular for seats, backrests and armrests, adequate flexibility should be achieved in order to facilitate comfortable sitting even over an extended period.

For this purpose, the leather has hitherto firstly been bonded to a foam layer in a separate working step, with the resultant composite then being adhesively bonded to the substrate, for example a molding of hard plastic. In both working operations, solvent-based adhesive systems, emulsion adhesives or two-component reactive resin systems are used, which means that unavoidable emissions of solvents and residual monomers must be accepted.

DE-A 214 437 I describes a process for the embossing lamination of leather in an HF field. The durable bond between a leather or support layer to PVC or PUR layers is produced here with concomitant use of a heat-reactivable adhesive, optionally containing blowing agent, in a high-frequency press with simultaneous embossing in the same working step.

DE 197 520 58 describes a process for the foam backing of shaped leather pieces having a lap seam. In this process, a shaped leather piece is laid by means of its front side onto the mold half of a suitable mold, and the plastic material is then applied to the reverse of the leather piece in this mold with at least slight development of pressure. In accordance with the invention, the step-like height difference encountered in the region of the lap seam between the upper leather piece and the lower leather piece is compensated by a transition piece inserted between the leather front and the mold half. No further details are given on the process conditions for foam backing of the leather with the plastic material.

EP 0 337 183 B1 describes a process for the shaping of natural leather, in particular real leather coverings of moldings. In this process, a polyurethane barrier layer is pressed into the underside of the leather and reactivated by warming. The viscosity and amount of the polyurethane layer applied to the underside before the pressing operation are matched to one another in such a way that the thickness of the barrier layer makes up from 35% to 65% of the thickness of the leather layer. After the barrier layer, a molding is then foam-backed.

DE 198 151 115 A1 describes a leather-laminated internal trim part and a process for bonding a real leather layer to a substrate. The leather-laminated internal trim part for vehicles has a rigid support molding or a flexible spacer cushion part, on which a real leather is arranged by means of an adhesive bonding layer. The adhesive bonding layer consists of a sheet-like support structure and a heat-reactive hot-melt adhesive which has been metered onto the former in advance. In order to produce the internal trim part, the individual layers are arranged one on top of the other and warmed briefly under contact pressure to a temperature at which the hot-melt adhesive melts.

DE 198 180 34 describes a device for the production of foam-backed leather parts, in particular leather covering parts for the internal trim of vehicles. Here, a leather part is placed in a mold having an upper mold and a lower mold, the mold is closed, and the reverse of the leather part in the mold is foam-backed correspondingly. A plurality of such molds are installed on a turntable unit, with each mold passing through at least the following stations in the course of the rotational movement of the turntable: an insertion station, a bonding station, a foam introduction station, a curing station and a removal station.

Attempts have also been made to back leather directly with plastics in an injection mold. Thus, S. Anders et al., Kunststoffe 80 (1990), 997-1001, report attempts to back leather with plastics in injection molds. EP 0 199 708 A2 describes a process for the production of at least two-layer articles in which a leather strip is laid in an injection mold and backed with a thermoplastic rubber in an injection mold. The temperature of the plastic in the space in front of the screw is about 250° C., the temperature of the mold is on average 40° C., and the injection pressure is 100 bar. However, these experiments were only carried out on pieces of sample of very small size, for example watch straps. However, transfer into mass production of, in particular, large-area leather composite components has hitherto failed. The reason for this is that in the processes disclosed hitherto, it has not been possible to obtain a leather surface which exhibits a satisfactory external appearance. The surfaces were irregular, exhibited an uneven color and had flaws, such as cracks or folds. In particular leather/plastic components having a soft surface cannot, for example according to Woite et al., “Niederdruckverfahren für dekorative Innenausstattungs-teile” in “Kunststoffe im Automobilbau: Rohstoffe, Bauteile, Systeme”, VDI-Verlag, Dusseldorf, 1994, p. 303, be obtained without additional measures which prevent the plastic material penetrating into the leather.

It is an object of the present invention to provide a process for the production of a multilayered composite element which comprises a layer of leather, a layer of a hard component formed from a polymer, which is bonded to the leather layer in certain areas at least, and a layer of a soft component, which is arranged between the leather and the hard component, which process should be simple to carry out and the production of the multilayered composite element should if possible be performable in only a single working step. In particular, the aim is to produce a flexible leather surface of the multilayered composite element.

We have found that this object is achieved in the process designed in accordance with the invention by laying the leather against one mold surface of a mold, positioning the soft component on the leather, and molding the polymer acting as hard component onto the leather layer and the soft component layer at a pressure of at least 50 bar, preferably greater than 100 bar, in particular greater than 180 bar, and at a temperature of greater than 100° C., preferably from 180 to 280° C, in particular from 200 to 250° C., by bonding the leather and the hard component to one another in certain areas at least, with the temperature of the mold surface of the mold being controlled, at least during the bonding.

The soft component is suitably cut into such a shape that the leather layer projects in the edge regions. During molding-on of the hard component, a strong bond is formed between the leather and the hard component in the edge regions of the composite element. The bonding here takes place without the action of an adhesive. It is assumed that the polymer penetrates into the leather due to the high pressure and high temperature and so produces an irreversible bond. The bond between the leather and polymer of the hard component is so strong that in an attempt to separate the leather and polymer layer from one another, the structure of the leather or the hard component is destroyed. Furthermore, a durable bond is produced between the soft component and the hard component. A working step in which adhesive is applied to the leather of the soft component is superfluous. Thus, emissions of solvents and residual monomers from the adhesive are completely avoided. The soft component is surrounded by the leather layer and the hard component in a sandwich-like manner. Due to this production of a sandwich structure, the soft component is fixed durably and in a dimensionally stable manner in a pocket. The soft component makes the leather layer flexible and creates a pleasant soft feel on touching. Due to the combination with the hard component, the composite element can be brought into a certain shape, for example the shape of a dashboard, and achieves high stability. The molding is very robust and exhibits high resistance to the effects of temperature and humidity. The thickness of the soft component layer can be varied within broad limits. Thus, thicknesses of a few millimeters can be provided for dashboard or door linings in automobiles, while thicknesses of up to several centimeters can also be achieved for design as a seat. The process according to the invention also enables durable lamination of moldings with difficult shapes.

All common grades of leather can be used for the process according to the invention. The temperature control of the mold surface effectively prevents over-heating and destruction of the leather layer by the thermoplastic polymer applied at high pressure and high temperature. It is possible to process both leathers tanned using metal salts, e.g. chrome leather, which have a high hydrothermal stability of approximately 100° C., and other leathers which have a hydrothermal stability of approximately 70° C. Examples of such leathers are vegetable leather, chamois leather and FOC (free of chrome) leather. Leathers tanned using metal salts generally have higher heat shrinkage.

Leathers tanned using metal salt (for example chromium and aluminum) and leathers which are free of metal salts and processes for their production are described in detail, for example, in “Das Leder”, volume 43 (1992), page 283 ff.

Particularly flaw-free leather surfaces are obtained if the mold surface in contact with the leather is held at temperatures in the range from 40 to 80° C., preferably 45-75° C., particularly preferably 48-70° C. and in particular 50-60° C., during the backing with the molten plastic material.

Both untreated or partially treated and treated leathers can be employed.

In leather production by the wet-end and finish processes, the process chemicals and dyes are usually selected in such a way that they withstand the pressure and the thermal conditions of the in-mold backing operation. In particular, the fat-liquoring agents used in the wet-end area are preferably immobilized in the collagen network in such a way that fat migration to the surface or into the plastic does not occur during in-mold backing. Undesired shiny spots and fat impurities on the surface of the molding or an impairment in the adhesion between leather and plastic otherwise occur. The tanning agents used in pre-tanning and post-tanning are generally selected in such a way that good fiber separation occurs and the leathers have good light and heat resistance. This can be achieved, in particular, with glutaraldehyde, alone or in combination with synthetic tanning agents based on dihydroxydiphenyl sulfone. Irrespective of the tanning agent selected, the leather obtained by the wet-end process advantageously has an adequately high shrinkage temperature of at least 70° C. in the wet state.

The thickness of the leather used is generally independent of the shape and application of the leather component and can vary in the range from 0.4 to 3.0 mm, with a thickness in the range from 0.4 to 2.0 mm, preferably from 0.8 to 2.0 mm and in particular from 1.2 to 1.8 mm, generally meeting most requirements.

The pressure with which the bond between the leather layer and the hard component is produced is restricted per se only by the technical boundary conditions of the mold used. A durable bond between the leather and the polymer is achieved at pressures from as low as 50 bar. Very good results are achieved at pressures greater than 100 bar, in particular greater than 180 bar. In the case of very large workpieces, for example dashboards, significantly higher pressures of, for example, 1000 bar are also used.

The internal pressure in the mold, measured in the vicinity of the gate, is preferably at least 50 bar, particularly preferably at least 100 bar and in particular at least 180 bar.

The processing temperature is selected depending on the polymer employed. Advantageous for a good bond between the leather and the hard component is high flowability of the polymer. The melt flow rate (MFR) 230/2.16 is favorably selected to be >5 g/10 min, preferably between 10 and 50 g/10 min. The melt flow rate (MFR) is determined in accordance with ISO 1133 at 230° C. and under a weight of 2.16 kg. A low content of wetting agents, such as glycerol monostearate, in the polymer is likewise advantageous for good adhesion. Contents of less than 5000 ppm of wetting agent have proven favorable.

The soft component used can per se be any material which has adequate flexibility and elasticity. The soft component is particularly advantageously a polymer foam. Furthermore, suitable soft components are also textile inlays or nonwovens or polyester nonwovens, in each case with or without fiber composites, for example made from glass or carbon fibers. The soft component should suitably have a heat resistance of greater than 150° C. The heat resistance of the soft component must be selected so that the soft component retains its flexibility and elasticity during foam-backing with the hard component. Apart from the above-mentioned requirements, the polymer used as soft component is not subjected to any restrictions per se. An appropriately shaped piece of the foamed polymer is preferably positioned on the leather surface. It can be held by a correspondingly shaped cavity of the injection mold, in which the leather has already been positioned. If necessary, the foam can also be held in place by an adhesive film. During molding-on of the hard component, the polymer foam bonds to the polymer of the hard component, thereby effecting durable fixing within the composite.

The polymer foam is compressed during injection and attempts to return to its original shape after decompression. The leather surface is thereby placed under a slight tension, producing tight cushioning. In the finished composite, the polymer foam is not bonded to the leather or at best is bonded to the leather by an adhesive layer used for holding the polymer foam during production.

The polymer foam is generally formed from a foamable polymer crosslinked with wide meshes. The polymer acting as soft component is preferably a thermoplastic elastomer. Thermoplastic elastomers (TPEs) are not characterized by their chemical composition, but instead by their material states. Suitable thermoplastic elastomers are generally distinguished by simultaneously having soft and elastic segments of low glass transition temperature and hard, crystallizable segments of low extensibility, high glass transition temperature and tendency toward associate formation. The mutually incompatible hard and soft segments exist in phases which have not been penetrated. Hard and soft segments can be constituents of a single polymer or in the form of a mixture of elastomers and thermoplastics in a microheterogeneous phase distribution. The thermo-dynamically incompatible phases can be in the form of three- or multiblock copolymers in the same macromolecule or also in the form of elastomer blends. Accordingly, incompatible phases of hard, meltable and soft, elastic components are bonded to one another. After elongation by 100% or more, TPEs return to the original state very spontaneously and without significant elongation after the stress is released. All known thermoplastic elastomers can per se be used as the soft component. Particularly suitable are styrene oligoblock copolymers (TPE-S), such as styrene-butadiene-styrene, styrene-isoprene-styrene or styrene-ethene-butadiene-styrene block copolymers, for example the commercial products Kraton® D, Cariflex® TR and Kraton® G, thermoplastic elastomers based on olefins (TPE-O), such as mixtures of EPM or EPDM rubbers with crystalline polyolefins, for example polypropylene, for example the commercial product Ferrolene® (Ferro), thermoplastic polyurethanes (TPE-U), for example the commercial products Desmopan® (Bayer AG) and Estane® (Goodrich), copolyester grades (TPE-E), such as copolymeric polyether-esters, for example the commercial product Hytrel® (DuPont), and copolyamide grades (TPE-A), such as polyether block amides, for example the commercial product Pebax® (Atochem). Furthermore, thermoplastic elastomers that can be employed are also thermoplastic natural, nitrile, fluoro and silicone rubber.

The preparation and properties of suitable thermoplastic elastomers are described, for example, in Ullmann's Encyclopedia of Industrial Chemistry, Vol. A26, pp. 633-664, VCH Verlagsgesellschaft, 1995, Weinheim.

Since the polymer foam must not melt and consequently collapse during foam backing with the hard component, polyurethane elastomers are particularly preferred.

As a natural material, leather cannot be subjected to any desired high temperatures without denaturing of the leather structure taking place. Conventional chrome leathers have a hydrothermal stability of approximately 100° C., while other leathers have a hydrothermal stability of approximately 70° C. It has now been found that boiling of the leather and destruction of the leather structure during bonding of the leather to the polymer of the hard component at high pressure and high temperature can be effectively prevented if the mold surface in contact with the leather is cooled to a temperature of from 10 to 80° C., preferably from 20 to 60° C. The leather side of the finished molding shows no change in its appearance due to bonding to the hard component. Likewise, the feel of the leather surface imparted on touching the finished molding corresponds to the typical feel of leather. In spite of the use of high temperatures and high pressure during bonding of the leather layer and soft component, the leather side of the finished composite piece exhibits a certain flexibility and softness. Due to the soft component, the leather layer is elastically supported and retains its natural structure.

Due to the cooling the mold surface, the hydrothermal stressing of the leather is low. For processing, it has proven favorable for the leather to be as dry as possible. The leather preferably has a moisture content of less than 20% by weight.

It has been found that at temperatures of at least 40° C., formation of sweat spots on the leather surface is avoided. Although the injected plastic solidifies rapidly if the temperature of the heated mold surface is chosen to be as low as possible and thus allows short cycle times since the finished molding can be removed from the mold very rapidly, it is at the same time advantageous to inject at very high pressure in order to be able to fill the mold cavity completely before the plastic solidifies. If the temperature of the heated mold surface is selected to be below 40° C., a problem occurs that the leather is subjected to very high mechanical loads, which may result in deformation or cracking.

If the heated mold surface is heated to a temperature of above 80° C., thermal stressing of the leather increases greatly, with the consequence that increasing destruction of the leather structure is observed, which results in unacceptable reductions in the quality of the molding produced. In addition, the cycle times in the production of the moldings increase significantly since the plastic is solidified more slowly owing to the low temperature difference between injected plastic and heated mold surface.

In particular if the temperature of the heated mold surface is kept in the range 50-60° C., high-pressure backing is possible at high temperatures, for example at a temperature of above 100° C., preferably in the range 180-280° C., particularly preferably in the range from 200 to 250° C., without the leather being adversely affected, even in long-term operation. The heating times here can even be in the region of minutes. The process described also allows thin-wall injection-molding applications to be carried out.

Suitable thermoplastics are, inter alia, polypropylene, polyethylene, polyvinyl chloride, polyether sulfones, polysulfones, polyether ketones, polycycloolefins, poly(meth)acrylates, polyamides, polycarbonates, polyphenylene ethers, polyurethanes, polyacetals, for example polyoxymethylene, polyesters, for example polybutylene terephthalates, polystyrenes and styrene (co)polymers, such as ABS, AES, ASA or SAN polymers. Both homopolymers and copolymers of these thermoplastics can be used here.

Particularly suitable are ABS polymers (these are, inter alia, impact-modified styrene/acrylonitrile polymers in which graft copolymers of styrene and acrylonitrile on polybutadiene rubbers exist in a copolymer matrix of styrene and acrylonitrile), ASA polymers, SAN polymers, mixtures of poly(meth)acrylates and SAN polymers which have been impact-modified by means of polyacrylate rubbers (for example Terlux® BASF AG), polypropylene, polyamides, polybutylene terephthalate, polyethylene, thermoplastic polyurethanes, polycarbonate or mixtures thereof, for example PPE/HIPS (high impact polystyrene) blends, for example commercially available under the trade name Luranyl® (BASF AG). Preferred polymer blends are based on ASA/PC, ABS/PC, PBT/ASA, PBT/ABS and PBT/PC mixtures.

The abovementioned polymers are generally known and are described, for example, in H. Domininghaus, Die Kunststoffe und ihre Eigenschaften, VDI-Verlag, Dusseldorf, 1992.

The polymers employed as hard component may also comprise regrind of these thermoplastics or consist completely or virtually completely of regrind.

The preferred polybutylene terephthalate is a high-molecular-weight product of the esterification of terephthalic acid with butylene glycol which has a melt flow rate (MFR) in accordance with ISO 1133, at 230° C. and under a weight of 2.16 kg, of from 5 to 50 g/10 min, in particular from 5 to 30 g/10 min.

Suitable copolymers of styrene are, in particular, copolymers containing up to 45% by weight, preferably up to 20% by weight, of copolymerized acrylonitrile. Styrene-acrylonitrile (SAN) copolymers of this type have a melt flow rate (MFR) in accordance with ISO 1133, at 230° C. and under a weight of 2.16 kg, of from 1 to 25 g/10 min, in particular from 4 to 20 g/10 min.

Further likewise preferred styrene copolymers contain up to 35% by weight, in particular up to 20% by weight, of copolymerized acrylonitrile and up to 35% by weight, in particular up to 30% by weight, of copolymerized butadiene. The melt flow rates of such copolymers of styrene, acrylonitrile and butadiene (ABS), in accordance with ISO 1133, at 230° C. and under a weight of 2.16 kg, are in the range from 1 to 40 g/10 min, in particular in the range from 2 to 30 g/10 min.

The term ASA polymers is generally taken to mean impact-modified styrene-acrylonitrile polymers in which graft copolymers of vinyl-aromatic compounds, in particular styrene, and vinyl cyanides, in particular acrylonitrile, on polyalkyl acrylate rubbers are present in a copolymer matrix of, in particular, styrene and acrylonitrile. ASA polymers are commercially available, for example under the name Luran® S (BASF AG).

Suitable polycarbonates are known per se. Particularly preferred polycarbonates are those based on bisphenol A or bisphenol A together with up to 80 mol % of further aromatic dihydroxyl compounds. Commercially available polycarbonates are, for example, Makrolon® (Bayer AG) and Lexan® (GE Plastics B.V.). Also suitable are copolycarbonates based on bisphenol A and, for example, bis(3,5-dimethyl-4-hydroxyphenyl) sulfone or 1,1-di(4-hydroxyphenyl)-3,3,5-trimethylcyclohexyl, which are distinguished by their high heat distortion resistance. The last-mentioned copolycarbonate is commercially available under the trade name Apec® HT (Bayer AG). The polycarbonates can be employed in ground or granulated form. As a mixture constituent, in particular in an ASA substrate layer, polycarbonates are usually present in amounts of from 1 to 80% by weight, preferably from 9 to 50% by weight and particularly preferably from 15 to 45% by weight, based on the particular mixture. The addition of polycarbonates results, inter alia, in higher thermal stability and improved cracking resistance of the composite films.

Further polymer materials are, in particular, also polyolefins, such as polyethylene or polypropylene, the latter being preferred. The term “polypropylene” here is taken to mean both homopolymers and copolymers of propylene. Copolymers of propylene contain secondary amounts of monomers which can be copolymerized with propylene, for example C₂- to C₈-alk-1-enes, such as, inter alia, ethylene, but-1-ene, pent-1-ene or hex-1-ene. It is also possible to use two or more different comonomers.

Particularly suitable supports are, inter alia, homopolymers of propylene or copolymers of propylene with up to 50% by weight of copolymerized other 1-alkenes having up to 8 carbon atoms. The copolymers of propylene here are random copolymers or block or impact copolymers. If the copolymers of propylene have a random structure, they generally contain up to 15% by weight, preferably up to 6% by weight, of other 1-alkenes having up to 8 carbon atoms, in particular ethylene, 1-butene or a mixture of ethylene and 1-butene.

Block or impact copolymers of propylene are polymers in which, in the first step, a propylene homopolymer or a random copolymer of propylene with up to 15% by weight, preferably up to 6% by weight, of other 1-alkenes having up to 8 carbon atoms is prepared and then, in the second step, a propylene-ethylene copolymer having ethylene contents of from 15 to 80% by weight, where the propylene-ethylene copolymer may additionally contain further C₄-C₈-alk-1-enes, is polymerized on. In general, sufficient of the propylene-ethylene polymer is polymerized on so that the copolymer produced in the second step has a proportion of from 30 to 60% by weight in the end product.

The polymer material may comprise, based on the total weight of the support, from 1 to 60% by weight, preferably from 5 to 50% by weight, particularly preferably from 10 to 40% by weight, of reinforcing fillers, for example sawdust, amorphous silica, magnesium carbonate, magnesium hydroxide, chalk, powdered quartz, mica, bentonite, talc, in particular having a mean particle size in the range from 0.1 to 10 μm, measured in accordance with DIN 66115, calcium carbonate, barium sulfate, glass beads, feldspar or, in particular, calcium silicates, such as wollastonite and kaolin.

Also suitable are fibers, which for the purposes of the present invention is also taken to mean platelet-shaped products.

Examples which may be mentioned of fibrous fillers are carbon, aramid, steel or glass fibers, aluminum flakes, cut glass or rovings. Particular preference is given to glass fibers. The fibers employed may furthermore be natural fibers, such as flax, hemp, jute, sisal, ramie or carnaf.

The glass fibers used can be made of E, A or C glass and are preferably provided with a size and/or an adhesion promoter. Both continuous fibers (rovings) and cut-glass fibers (staple) can be employed.

It is also possible to use mixtures of fibers and/or particulate fillers.

In addition, the conventional additives, such as light, UV and heat stabilizers, carbon blacks, lubricants, waxes, effect colorants or flame retardants and the like, can be added to the polymer material in the conventional and requisite amounts.

According to a particularly advantageous embodiment of the process, the bonding of the hard component and the leather is carried out by injection molding. In this case, the leather piece is laid in the mold cavity, then, for example, a polymer foam is positioned on the leather surface, and subsequently the hard component is injection-molded onto the back of the leather and polymer foam.

Molds which can be used in the process according to the invention are the apparatuses which are conventional in plastics technology, for example injection molds for injection molding. It is essential that adequate heat dissipation can be ensured in each case on the leather side of the composite element. To this end, corresponding cooling of the injection mold is usually provided.

During injection molding, the leather layer and the polymer foam are either three-dimensionally pre-shaped directly by a thermoforming process, and the hard component is subsequently injection-molded onto the back in an injection mold, or the leather is thermoformed directly in the injection mold by the inflowing polymer melt.

For the production of the multilayered composite element, recourse can also be made, besides to injection molding, to suitable impression molding processes, for example deposit compression molding or mat hot pressing. For deposit compression molding, suitable processes are, for example, melt-flow compression molding and melt application compression molding. The above processes are also described in Weite et al., “Niederdruckverfahren für dekorative Innenausstattungsteile” in “Kunststoffe im Automobilbau: Rohstoffe, Bauteile, Systeme”, VDI-Verlag, 1994, Dusseldorf, pp. 280-312.

According to an embodiment of the process, the hard component is heated to a temperature of at least 150° C. in an extruder and extruded. The leather and the soft component are fed to the extruded hard components over temperature-controlled calender or embossing rolls, and the leather layer, the soft component layer and the hard component layer are bonded to one another under pressure. The warmed thermoplastic polymer is ejected in a suitable manner through an appropriately shaped slot die.

The three-dimensional shaping of the leather component, soft component and hard component can be carried out within the mold, i.e. the calender or embossing roll. In this case, the composite element is heated to the requisite high temperatures on the side of the hard component, while the composite element is cooled on the leather side.

The composite elements which can be produced by the process according to the invention exhibit extremely favorable properties. The invention therefore also relates to a multilayered composite element having a layer of leather, a layer of a hard component and a layer of a soft component, which is arranged between the leather layer and the hard component layer, where the leather and the hard component are bonded to one another in certain areas without an adhesive, in particular the hard component has at least partially penetrated into the leather in the areas.

The leather layer and the hard component are irreversibly bonded to one another by the thermoplastic polymer which has penetrated into the leather layer. Separation of the leather layer from the underlying support is in the case of most conventional plastics only possible with destruction of the leather layer. In the three-dimensional composite element according to the invention, no further material is necessary as adhesive for bonding the leather layer and the hard component. Characteristic of the three-dimensional composite element according to the invention is thus the absence of an adhesive layer between the leather and hard components

For good bonding between the leather layer and the hard component, it has proven favorable for the penetration depth of the first polymer into the leather to be from 5 to 40%, preferably from 10 to 30%, of the thickness of the leather layer. The requisite penetration depth depends on the leather thickness and on the demands regarding mechanical resistance.

The composite elements according to the invention can be employed in a multiplicity of applications, in particular for large-area composite components. Besides the above-mentioned use in the automobile industry for the covering of dashboards, for internal trim, central consoles, etc., it is conceivable to design the composite element as, for example, a protective cover for mobile telephones, covering of shell suitcases with leather surfaces or use in the shoe or clothing industry for caps, shoulder pieces and individual parts of protective clothing which are injection-molded on directly. A further area of application is, for example, the furniture industry. Here, a design of the composite element as a backrest, seat or armrest of seating furniture is conceivable. The invention can be used well beyond the said illustrative uses. It offers particular advantages in the case where, besides the visual properties, the feel created on touching the leather surface is also important.

The invention is explained in greater detail below with reference to a drawing, in which:

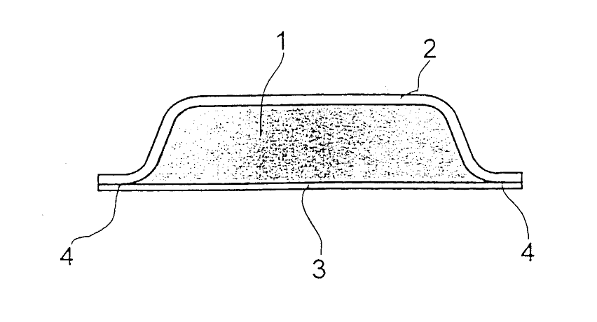

FIG. 1 shows a cross section through a molding according to the invention.

FIG. 1 shows a cross section through a composite element according to the invention. The composite element comprises a core 1 of a polymer foam, which is surrounded on one side by a layer 2 of leather and on the other side by a layer 3 of a hard component. The hard component has a certain rigidity and is formed, for example, of polypropylene. The leather layer 2 and the hard component 3 form a pocket, which is filled by the polymer foam 1. In the edge regions 4, the layer 2 of leather and the hard component 3 touch without polymer foam 1 being arranged between them. In these regions 4, the leather layer 2 and the hard component 3 are bonded to one another without an adhesive, with the hard component 3 penetrating somewhat into the leather layer 2. In the regions in which the polymer foam 1 and the hard component 3 are in contact with one another, a durable bond is likewise formed by the injection-molded backing with the hard component. The bond between the leather layer 2 and the hard component 3 need not necessarily occur in the edge regions of the molding. Contact points with the leather layer 2, at which the leather layer and the hard component are durably bonded, may also be provided within the surface of the hard component 3.

1. A process for the production of a multilayered composite element which comprises a layer of leather, a layer of a hard component formed from a polymer, which is bonded to the leather layer in certain areas, and a layer of a soft component, which is arranged between the leather component and the hard component, which comprises laying the leather against one mold surface of a mold, positioning the soft component on the leather, and molding the polymer acting as hard component onto the leather layer and the soft component layer at a pressure of at least 50 bar, preferably greater than 100 bar, in particular greater than 180 bar, and at a temperature of greater than 100° C., preferably from 180 to 280° C., in particular from 200 to 250° C., by bonding the leather and the hard component to one another in certain areas at least, with the temperature of the mold surface of the mold being controlled, at least during the bonding.

2. A process as claimed in claim 1, wherein the mold surface in contact with the leather is held at a temperature of from 10 to 80° C., preferably from 20 to 60° C.

3. A process as claimed in claim 1 or 2, wherein the soft component is a polymer foam.

4. A process as claimed in claim 4, wherein the polymer foam is formed from a polymer crosslinked with wide meshes, preferably a thermoplastic elastomer, in particular from polyurethane elastomers.

5. A process as claimed in one of claims 1 to 4, wherein the leather has a moisture content of less than 20% by weight.

6. A process as claimed in one of claims 1 to 5, wherein the polymer of the hard component is selected from the group which is formed from polypropylene, polyethylene, polyvinyl chloride, polyether sulfones, polysulfones, polyether ketones, polycycloolefins, poly(meth)acrylates, polyamides, polycarbonates, polyphenylene ethers, polyurethanes, polyacetals, polybutylene terephthalates, polystyrene, styrene (co)polymers and mixtures thereof.

7. A process as claimed in one of claims 1 to 6, wherein the hard component and the leather are bonded by injection molding.

8. A process as claimed in one of claims 1 to 6, wherein the hard component is heated to a temperature of at least 150° C. in an extruder and extruded, the leather and the soft component are fed to the extruded hard component over temperature-controlled calender or embossing rolls, and the leather layer, the soft component layer and the hard component layer are bonded to one another under pressure.

9. A multilayered composite element having a layer of leather, a layer of a hard component and a layer of a soft component, which is arranged between the leather layer and the hard component layer, where the leather and the hard component are bonded to one another without an adhesive in areas, in particular the hard component has at least partially penetrated into the leather in the areas.

10. A multilayered composition element as claimed in claim 9, wherein the penetration depth of the polymer forming the hard component into the leather is from 5 to 40%, preferably from 10 to 30%, of the thickness of the leather layer.
